(19) United States
(12) Patent Application Publication
(10) Pub. No.: US 2026/0368927 A1
(43) Pub. Date: Nov. 19, 2026

(54) Automated Pose-Based Camera Calibration

(71) Applicant: Disney Enterprises, Inc., Burbank, CA (US)

(72) Inventors: Dominik Tobias Borer, Greifensee (CH); Mattia Gustavo Bruno Paolo Ryffel, Bidogno (CH); Martin Guay, Unterengstringen (CH); Jakob Joachim Buhmann, Zurich (CH); Robert W. Sumner, Zurich (CH)

(21) Appl. No.: 18/631,582

(22) Filed: Apr. 10, 2024

(51) Int. Cl. G06T 7/80; G06T 3/147; G06T 7/73; G06V 40/10

(52) U.S. Cl. CPC G06T 7/80; G06T 3/147; G06T 7/75; G06V 40/10; G06T 2207/10016; G06T 2207/30196; G06T 2207/30241; G06T 2207/30244

(57) ABSTRACT

A system includes a hardware processor and a system memory storing software code. The hardware processor executes the software code to receive a plurality of video sequences each generated by a respective one of a plurality of cameras, each of the video sequences depicting a respective one of a plurality of three-dimensional (3D) movements of a subject from a different perspective, align a respective direction of a 3D trajectory of the subject in each of the video sequences, and predict, after aligning, a sequence of poses of the subject based on a plurality of predetermined keypoints of the subject in each video frame of the video sequences. The hardware processor is further configured to execute the software code to calibrate, based on the 3D movements and the sequence of poses, a location of each of the cameras.

### BACKGROUND

In applications in which multiple video cameras are used to record the motion of an object or other subject, it is often necessary to spatially calibrate those cameras in order to sensibly merge the different perspective each camera captures. Conventional techniques for performing spatial calibration of cameras typically rely on external markers such as fixed quick-response (QR) codes, calibration boards or other visual cues, audio cues, or specifically designed hardware for generating the data required to identify the respective camera locations. These conventional approaches all rely on features or technologies that are not required for the underlying performance or interaction that is the subject of the videography, and thereby undesirably introduce the use of unnecessary and extraneous elements. Consequently, there is a need in the art for a solution enabling the automated spatial calibration of video cameras based on the motion of the subjects recorded by those video cameras, without requiring the use of external markers for spatial benchmarking.

### BRIEF DESCRIPTION OF THE DRAWINGS

FIG. 1 shows an exemplary system for performing automated pose-based camera calibration, according to one implementation;

FIG. 2 shows a flowchart presenting an exemplary method for performing automated pose-based camera calibration, according to one implementation;

FIG. 3 shows a diagram representing the alignment of the directions of respective three-dimensional (3D) trajectories of a subject depicted by different cameras, according to one implementation;

FIG. 4 shows an exemplary image plane based two-dimensional (2D) diagram of a pose assumed by a skeleton having a plurality of joints, according to one implementation; and

FIG. 5 shows a diagram depicting the determination of a ground plane on which 3D movements of the skeleton in FIG. 4 occur, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, in applications in which multiple video cameras are used to record the motion of an object or other subject, it is often necessary to spatially calibrate those cameras in order to sensibly merge the different perspective each camera captures. Conventional techniques for performing spatial calibration of cameras typically rely on external markers such as fixed quick-response (QR) codes, calibration boards or other visual cues, audio cues, or specifically designed hardware for generating the data required to identify the respective camera locations. These conventional approaches all rely on features or technologies that are not required for the underlying performance or interaction that is the subject of the videography, and thereby undesirably introduce the use of unnecessary and extraneous elements.

The present application discloses systems and methods for performing automated pose-based camera calibration that address and overcome the drawbacks and deficiencies in the conventional art by advantageously enabling the automated spatial calibration of video cameras based on the motion of the subjects recorded by those video cameras, without the use of external markers for spatial benchmarking. That is to say, the solution disclosed in the present application advances the state-of-the-art by automating the spatial calibration of cameras, based exclusively on the pose and movement of the subject or subjects being tracked using those cameras. In addition to optimizing for the camera locations, the present automated pose-based camera calibration solution optimizes for a ground plane (e.g., a flat ground plane) for better foot tracking. In addition, when the movements of a plurality of subjects are tracked concurrently, the present novel and inventive solution can be used to spatially calibrate a moving camera, when other cameras are locked off, i.e., are not moving.

It is noted that as used in the present application, the terms “automation,” “automated” and “automating” refer to systems and processes that do not require the participation of a human system operator. Thus, the methods described in the present application may be performed under the control of the hardware processing components of the disclosed systems.

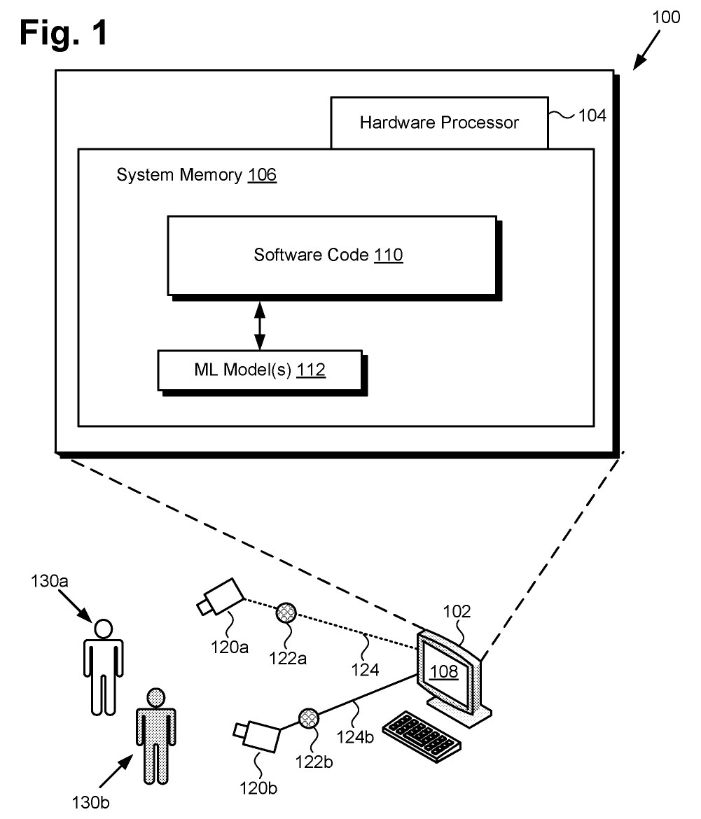

FIG. 1 shows exemplary system 100 for performing automated pose-based camera calibration, according to one implementation. As shown in FIG. 1, system 100 includes computing platform 102 having hardware processor 104, system memory 106 implemented as a non-transitory storage medium, and display 108. According to the present exemplary implementation, system memory 106 stores software code 110 and one or more trained machine learning (ML) models 112 (hereinafter “ML model(s) 112”).

It is noted that, as defined in the present application, the expression “ML model” refers to a computational model for making predictions based on patterns learned from samples of data (i.e., training data). Various learning algorithms can be used to map correlations between input data and output data. These correlations form the computational model that can be used to make future predictions on new input data. Such a predictive model may include one or more logistic regression models, Bayesian models, or artificial neural networks (NNs), large-language models, multimodal foundation models, as well as various classical artificial intelligence (AI) models, to name a few examples.

As further shown in FIG. 1, system 100 is implemented within a use environment including cameras 120a and 120b each communicatively coupled to computing platform 102, and one or more moving subjects 130a and 130b. In addition, FIG. 1 shows video sequences 122a and 122b generated by respective cameras 120a and 120b, and each depicting three-dimensional (3D) movements by one or more of subjects 130a and 130b from a different camera perspective. Also shown in FIG. 1 are wireless communication link 124a coupling camera 120a to computing platform 102 of system 100, and wired communication link 124b coupling camera 120b to computing platform 102.

It is noted that although subjects 130a and 130b are depicted as humanoid figures in FIG. 1, that representation is provided merely as an example. More generally one or more of subjects 130a and 130b may be or include a skeleton, such as a skeleton of a human being, animal, or a robot having articulated joints, for example. Alternatively, or in addition, in some use cases, one or more of subjects 130a and 130b may be a non-skeletal animate or inanimate object. Examples of an inanimate object may include a thrown ball, a projectile, or an autonomous or wirelessly controlled vehicle or toy, to name a few. It is further noted that although FIG. 1 depicts two subjects 130a and 130b, in various use cases, 3D movements by only one of subjects 130a or 130b may be tracked using cameras 120a and 120b, or the 3D movements of more than two subjects may be tracked using cameras 120a and 120b. In other words, in various implementations, subjects 130a and 130b may represent a single subject, two subjects, or more than two subjects.

It is also noted that, although FIG. 1 depicts two cameras 120a and 120b, in other implementations more than two cameras may be communicatively coupled to computing platform 102 by wired or wireless communication links and may be used to track one or more subjects 130a and 130b. Thus, in various implementations, cameras 120a and 120b may represent two cameras, or more than two cameras. Cameras 120a and 120b may be digital video cameras, for example. In some implementations, cameras 120a and 120b may be configured to capture color or black and white monocular digital images. In one such implementation, cameras 120a and 120b may be red-green-blue (RGB) color video camera(s), for example. Alternatively, or in addition, cameras 120a and 120b may be depth cameras, such as RGB-D cameras. In other implementations, cameras 120a and 120b may be or include infrared (IR) cameras, or may correspond to any other suitable optical sensor(s) for obtaining video sequences 122a and 122b of one or more of subjects 130a and 130b. Moreover, in some implementations, one or more of cameras 120a-120d may be a camera included as a feature of a personal communication device, such as a smartphone, for example.

Referring to system 100, system memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

Moreover, in some implementations, system 100 may utilize a decentralized secure digital ledger in addition to system memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

Although FIG. 1 depicts software code 110 and ML model(s) 112 as being co-located in a single instance of system memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100.

Hardware processor 104 may include a plurality of hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for AI applications such as ML modeling.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth, for instance to communicate with one or more of cameras 120a and 120b. Furthermore, in some implementations, system 100 may be implemented virtually, such as in a data center. For example, in some implementations, system 100 may be implemented in software, or as virtual machines. Moreover, in some implementations, system 100 may be configured to communicate via a high-speed network suitable for high performance computing (HPC), for example a 10 GigE network or an Infiniband network.

In other implementations, however, and as shown in FIG. 1, system 100 may take the form of a desktop computer, or alternatively a tablet computer, laptop computer, smartphone, or an augmented reality (AR) or virtual reality (VR) device, for example, providing display 108. Display 108 may take the form of a liquid crystal display (LCD), a light-emitting diode (LED) display, an organic light-emitting diode (OLED) display, a quantum dot (QD) display, or any other suitable display screen that performs a physical transformation of signals to light. Furthermore, display 108 may be physically integrated with computing platform 102 or may be communicatively coupled to but physically separate from computing platform 102. For example, where system 100 is implemented as a smartphone, laptop computer, or tablet computer, display 108 will typically be integrated with computing platform 102. By contrast, where system 100 is implemented as a desktop computer, its display 108 may take the form of a monitor separate from computing platform 102 in the form of a computer tower.

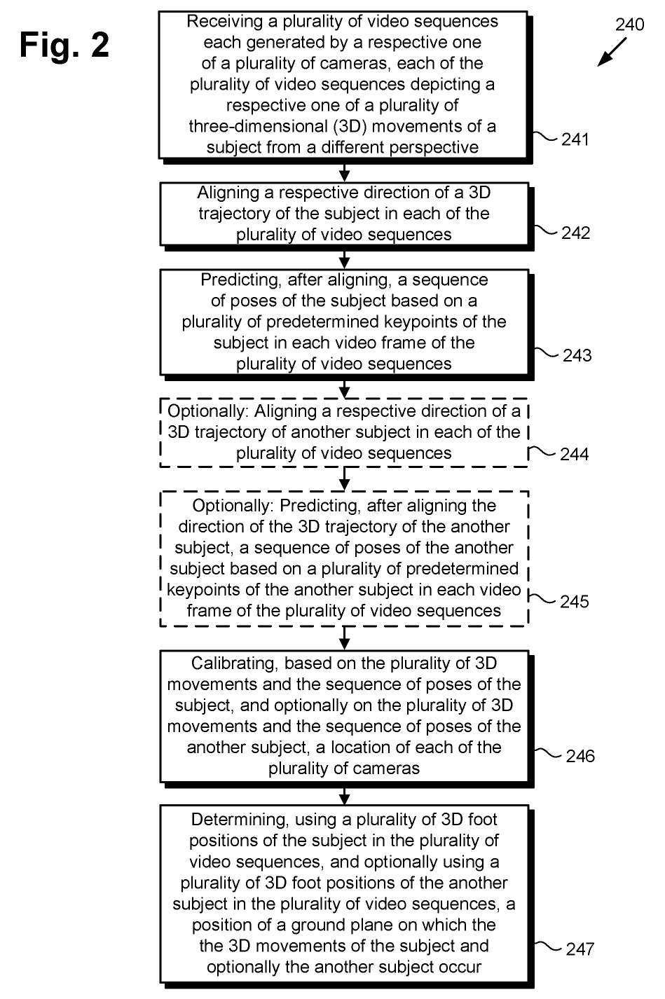

The functionality of system 100 including software code 110 and ML model(s) 112 will be further described by reference to FIG. 2. FIG. 2 shows flowchart 240 presenting an exemplary method for performing automated pose-based camera calibration, according to one implementation. With respect to the method outlined in FIG. 2, it is noted that certain details and features have been left out of flowchart 240 in order not to obscure the discussion of the inventive features in the present application.

By way of overview, in contrast to conventional approaches to spatially calibrating cameras using external visual markers, an audio cue, a dedicated movement pattern, or specialty hardware, the present novel and inventive approach relies only on tracking the movements of one or more subjects 130a and 130b, in FIG. 1, using tracking information provided by each of cameras 120a and 120b.

Referring to FIG. 2, with further reference to FIG. 1, flowchart 240 includes receiving video sequences 122a and 122b each generated respectively by cameras 120a and 120b, each of video sequences 122a and 122b depicting 3D movements of a subject (hereinafter “subject 130a”) from a different perspective (action 241). Each of video sequences 122a and 122b includes a plurality of video frames each including 2D and 3D tracking data of movements by subject 130a in a 3D space. Video sequences 122a and 122b may be received, in action 241, by software code 110, executed by hardware processor 104 of system 100.

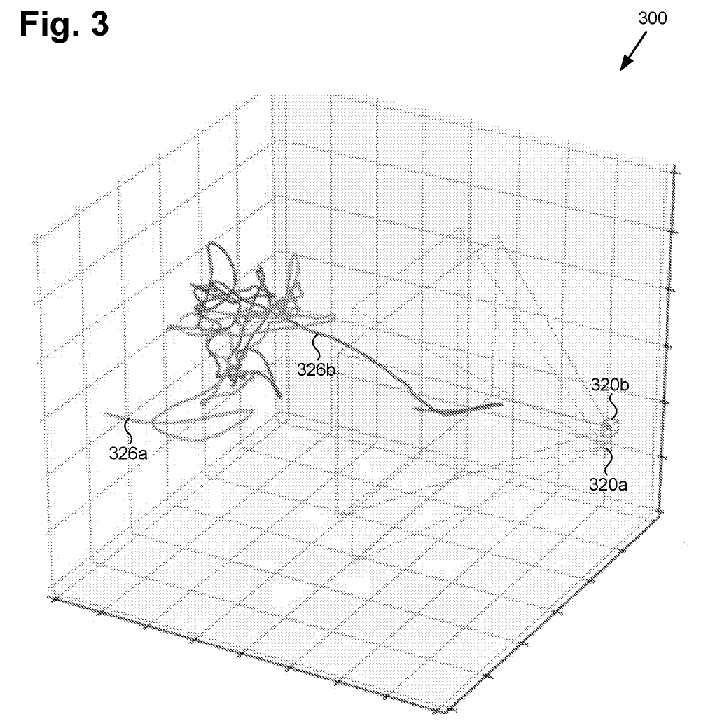

Continuing to refer to FIG. 2 in combination with FIG. 1, flowchart 240 further includes aligning a respective direction of a 3D trajectory of subject 130a in each of video sequences 122a and 122b (action 242). Referring further to FIG. 3, FIG. 3 shows diagram 300 representing the alignment of the directions of respective 3D trajectories 326a and 326b of subject 130a depicted by different respective cameras 320a and 320b, according to one implementation. It is noted that cameras 320a and 320b correspond respectively in general to cameras 120a and 120b in FIG. 1. Consequently, cameras 320a and 320b may share any of the characteristics attributed to respective cameras 120a and 120b by the present disclosure, and vice versa.

Alignment of the 3D trajectory predictions from each of cameras 120a/320a and 120b/320b may include solving for the affine transform that minimizes the difference between 3D trajectories 326a and 326b. In implementations in which cameras 120a/320a and 120b/320b are static cameras, only a single affine transform needs to be solved for, and the cost can be averaged over all frames of video sequences 122a and 122b. Alignment of 3D trajectories 326a and 326b, in action 242, may be performed by software code 110, executed by hardware processor 104 of system 100.

Continuing to refer to FIG. 2 in combination with FIG. 1, flowchart 240 further includes predicting, after the aligning performed in action 242, a sequence of poses of subject 130a based on a plurality of predetermined keypoints of subject 130a in each video frame of video sequences 122a and 122b (action 243). As noted above, in some implementations, subject 130a may be or include a skeleton, such as a skeleton of a human being, animal, or a robot having articulated joints, for example. In some of those implementations, the plurality of predetermined keypoints of subject 130a may be or include joints of that skeleton. In the case of an inanimate object lacking a skeleton, any predetermined point of interest, such as a vertex, a boundary point, or a centroid of the object, for example, may serve as a predetermined keypoint of subject 130a.

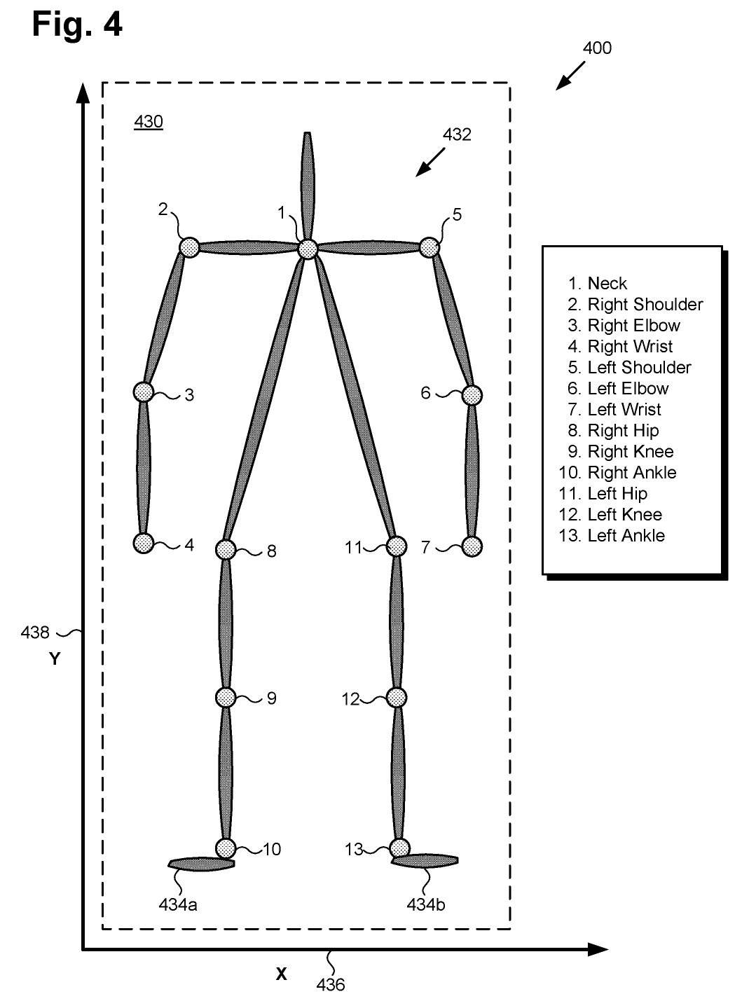

Referring for example to FIG. 4, FIG. 4 shows exemplary image plane based 2D diagram 400 of pose 432 assumed by skeleton 430 having a plurality of joints identified by reference numbers 1 through 13, as well having feet 434a and 434b, according to one implementation. It is noted that the image plane depicted in FIG. 4 is the plane defined by x-axis 436 and y-axis 438, where the x-axis 436 identifies a horizontal direction on the image plane and the y-axis 438 identifies a vertical direction perpendicular to the horizontal direction on the image plane.

It is further noted that skeleton 430 corresponds in general to either or both of subjects 130a and 130b in FIG. 1. Consequently, skeleton 430 (hereinafter “subject 430”) may share any of the characteristics attributed to subjects 130a and 130b by the present disclosure, and vice versa.

With respect to action 243, and referring to FIGS. 1, 3 and 4 in combination, because system 100 lacks a priori knowledge of the respective locations of cameras 120a/320a and 120b/320b relative to the 3D movement by subject 130a/430, the same 3D movement by subject 130a/430a may result in different 2D horizontally directed projections of that movement on the image plane defined by x-axis 436 and y-axis 438. For example, if cameras 120a/320a and 120b/320b were to be situated on the same side of subject 130a/430 with respect to x-axis 436 while subject 130a/430 moves, the respective horizontal image plane projections of that movement tracked by cameras 120a/320a and 120b/320b would share the same general direction on the image plane. Conversely, if cameras 120a/320a and 120b/320b were to be situated on opposite sides of subject 130a/430 with respect to x-axis 436 while subject 130a/430 moves, the respective horizontal image plane projections of that movement tracked by cameras 120a/320a and 120b/320b would be in opposite directions on the image plane.

Nevertheless, whether cameras 120a/320a and 120b/320b were to be situated on the same side or opposite sides of subject 130a/430 with respect to x-axis 436 while subject 130a/430 moves, the respective vertical image plane projections of that movement tracked by cameras 120a/320a and 120b/320b would be in the same direction on the image plane. Thus, in some implementations it may be advantageous or desirable to track the movement of subject 130a/430 by tracking the vertical projections of the motion of each of the joints of subject 130a/430 in the image plane defined by x-axis 436 and y-axis 438 while disregarding the horizontal projections of those joints on the image plane.

The sequence of poses may be predicted, in action 243, by software code 110, executed by hardware processor 104 of system 100. Moreover, in some implementations, that sequence of poses may be predicted, in action 243 using an ML model specifically trained to predict such poses and included among ML model(s) 112 of system 100.

Continuing to refer to FIG. 2 in combination with FIGS. 1, 3 and 4, in some implementations, flowchart 240 can continue from action 243 and conclude with calibrating, based on the 3D movements by subject 130a/430 and the sequence of poses predicted in action 243, a location of each of cameras 120a/320a and 120b/320b (action 246). Action 246 can optimize the respective 3D locations of cameras 120a/320a and 120b/320b, i.e., the respective positions and orientations of each of cameras 120a/320a and 120b/320b, based on a multi-view re-projection cost for the predicted sequence of poses of subject 130a/430 onto the image plane defined by x-axis 436 and y-axis 438. Thus, the location of each of cameras 120a/320a and 120b/320b calibrated in action 246 may be respective 3D locations of cameras 120a/320a and 120b/320b. Calibration of the location of each of cameras 120a/320a and 120b/320b may be performed, in action 246, by software code 110, executed by hardware processor 104 of system 100.

It is noted that action 243 optimizes the sequence of poses for subject 130a/430, while action 246 optimizes the respective locations of cameras 120a/320a and 120b/320b. It is further noted that actions 243 and 246 may be performed contemporaneously in an iterative fashion (i.e., predictive stages of action 243 that optimize only pose 432 of subject 130a/430, and calibration stages of action 246 that optimize only the respective locations of cameras 120a/320a and 120b/320b). In addition, actions 243 and 246 can further be supported by losses for temporal consistency and pose priors.

It is further noted that in, some implementations, the method outlined by flowchart 240 may include optional actions 244 and 245. That is to say, in some implementations, each of video sequences 122a and 122b may further depict a respective one of a plurality of 3D movements of another subject (hereinafter “subject 130b/430”). In those implementations, flowchart 240 may further include aligning a respective direction of a 3D trajectory of subject 130b/430 in each of video sequences 122a and 122b (action 244). When included in the method outlined by flowchart 240, action 244 may be performed by software code 110, executed by hardware processor 104 of system 100, in a manner similar to of action 242 described above.

It is also noted that although flowchart 240 depicts optional action 244 as following action 243, that representation is merely provided by way of example. In various implementations, action 244, when performed, may precede action 243, or follow action 243. Moreover, in some implementations, optional action 244 may be performed in parallel with, i.e., contemporaneously with, action 242.

In addition, in implementations in which the method outlined in FIG. 2 includes action 244, flowchart 240 may further include predicting, after aligning the direction of the 3D trajectory of subject 130b/430 in action 244, a sequence of poses of subject 130b/430 based on a plurality of predetermined keypoints of subject 130b/430 in each video frame of the video sequences 122a and 122b (action 245). When included in the method outlined by flowchart 240, action 245 may be performed by software code 110, executed by hardware processor 104 of system 100, in a manner similar to of action 243 described above.

Furthermore, it is noted that although flowchart 240 depicts optional action 245 as following action 243, that representation is merely provided by way of example. In some implementations, optional action 245 may be performed in parallel with, i.e., contemporaneously with, action 243, which may follow action 244.

In use cases in which feet 434a and 434b of subject 130a/430 or 130b/430 are within the respective fields of view of cameras 120a/320a and 120b/320b, the movement tracking predictions for subject 130a/430 and/or subject 130b/430 can also be used to solve for the ground plane, by detecting the frames of video sequences 122a and 122b in 2D in which the joints of feet 434a and 434b are not moving. Based on selectable filter heuristics and the combination of information from all views of cameras 120a/320a and 120b/320b, a best fit plane to the 3D points of those video frames can be identified as the ground plane on which the movements by subject 130a/430 and/or 130b/430 occur. For example, when using a small loss of ground contact and ground penetration, feet 434a and 434b of subject 130a/430 and/or 130b/430 can be iteratively optimized for better contact with the ground plane until convergence.

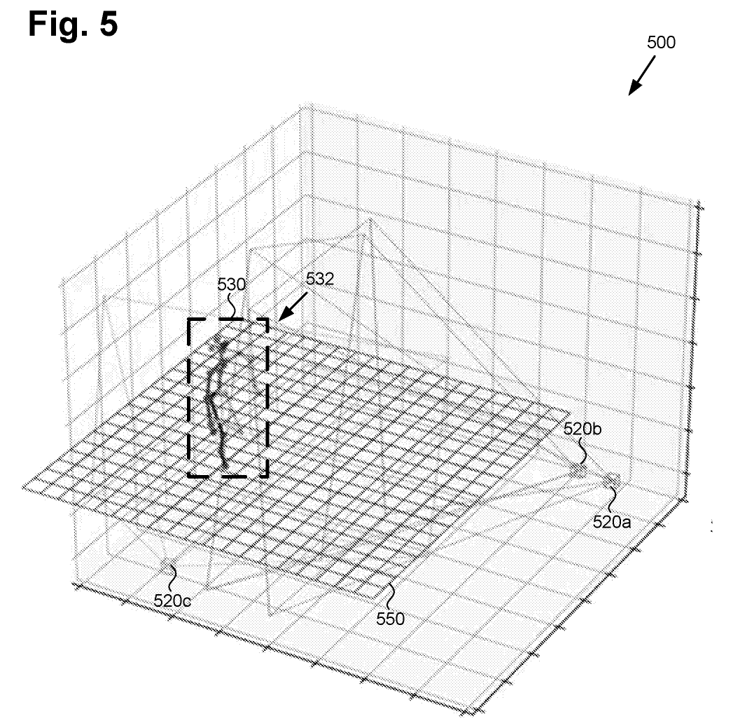

Referring to FIG. 5, FIG. 5 shows diagram 500 depicting the determination of ground plane 550 on which 3D movements of subject 130a/430 and/or 130b/430 occur, according to one implementation. In addition to ground plane 550, FIG. 5 shows subject 530 assuming pose 532, and cameras 520a, 520b and 520c. Subject 530 corresponds in general to any or all of subjects 130a, 130b and 430, in FIGS. 1 and 4. Consequently, subject 530 may share any of the characteristics attributed to subjects 130a, 130b, and 430 by the present disclosure, and vice versa. In addition, pose 532 assumed by subject 530 in FIG. 5, corresponds in general to pose 432 assumed by subject 430 in FIG. 4, and those corresponding poses may share any of the characteristics attributed to either feature by the present disclosure. Moreover, cameras 520a, 520b and 520c correspond in general to cameras 120a, 120b, 320a, and 320b in FIGS. 1 and 3. In other words, cameras 520a, 520b and 520c may share any of the characters attributed to cameras 120a, 120b, 320a, and 320b by the present disclosure, and vice versa.

Thus, referring to FIG. 2 in combination with FIGS. 1, 4 and 5, flowchart 240 may further include, determining, using a plurality of 3D foot positions of feet 434a and 434b of subject 130a/430/530 and/or subject 130b/430/530 in video sequences 122a and 122b, a position of ground plane 550 on which the plurality of the 3D movements of subject 130a/430/530 and/or subject 130b/430/530 occur (action 247). The ground plane determination performed in action 247 advantageously enables the estimation of more stable foot contact and prevents the undesirable appearance of foot sliding by subject 130a/430/530 and/or subject 130b/430/530. It is noted that, compared to conventional vision based systems for estimating ground plane 550, the present solution does not rely on any visual cues in the scene except for movements by subject 130a/430/530 and/or subject 130b/430/530. Action 247 may be performed by software code 110, executed by hardware processor 104 of system 100.

In some use cases the 3D foot positions of feet 434a and 434b of only one of subject 130a/430/530 or subject 130b/430/530 may be used to determine the position of ground plane 550. For example, the one of subject 130a/430/530 or subject 130b/430/530 who moves the most in video sequences 122a and 122b may have their 3D foot positions used to determine the position of ground plane 550 in action 247. However, in another use case, the position of ground plane 550 may be determined using the 3D foot positions of all subjects for whom feet 434a and 434b are within the respective fields of view of cameras 120a/320a and 120b/320b. That is to say, in those use cases the 3D foot positions of feet 434a and 434b of each of subject 130a/430/530 and subject 130b/430/530 may be used to determine the position of ground plane 550.

It is noted that, in some implementations, calibration of the location of each of cameras 120a/320a and 120b/320b in action 426 may be performed based on the 3D movements and sequence of poses of all of subjects 130a/430/530 and 130b/430/530 at the same time. This way all of subjects 130a/430/530 and 130b/430/530 are effectively calibration targets for cameras 120a/320a and 120b/320b, which can be beneficial in that more stereo constraints are created as a result. The same holds true for determination of the position of ground plane 550. Using the 3D foot positions of all of subjects 130a/430/530 and 130b/430/530 advantageously leads to a more robust solve due to more constraints.

Referring to FIG. 1, it is noted that in the case of a plurality of subjects 130a and 130b and a moving camera, the same approach can be used to calibrate the 3D location of the moving camera. In this case the moving camera has a per frame affine transform that needs to be optimized. It is further noted that this approach to calibrating a moving camera may only be possible in the multi-subject case, because a single subject is typically too small in the image space to faithfully decompose a transition and rotation in the image space. However, although the moving camera calibration typically only works in use cases in which a plurality of subjects 130a and 130b are present, that calibration does not rely on any static visual features in the scene besides movement by subjects 130a and 130b. As a result, the present automated pose-based camera calibration solution can be successfully utilized even when the visual scene is challenging, such as, for example, when the visual scene includes a perfect blue screen background.

With respect to the method outlined by FIG. 2, it is emphasized that actions 241, 242, and 243 (hereinafter “actions 241-243”), and action 246, or actions 241-243, 246 and 247, or actions 241-246, or actions 241-247, may be performed in an automated process from which human involvement, other than the 3D movements by one or more of subjects 130a/430/530 and 130b/430/530 may be omitted.

Thus, the present application discloses systems and methods for performing automated pose-based camera calibration that address and overcome the drawbacks and deficiencies in the conventional art by advantageously enabling the automated spatial calibration of video cameras based on the motion of the subjects recorded by those video cameras, without the use of external markers for spatial benchmarking. The solution disclosed in the present application advances the state-of-the-art by automating the spatial calibration of cameras, based exclusively on the pose and movement of the subject or subjects being tracked using those cameras. In addition to optimizing for the cameras, the present automated pose-based camera calibration solution advantageously optimizes for a ground plane for better foot tracking. In addition, when the movements of a plurality of subjects are tracked concurrently, the present novel and inventive solution can be used to spatially calibrate a moving camera, when other cameras are not moving.

Moreover, it is noted that a 3D pose directly predicted by a neural network is often diffused and inaccurate with respect to 2D keypoints and may result in inaccurate camera parameters. The present pose-based camera calibration solution addresses and overcomes this problem for the 3D pose and camera parameters jointly in an iterative fashion. In other words, the present solution does not fix the camera parameters and then optimize a 3D pose to fit a 2D pose, but rather advantageously improves both camera parameters and the 3D pose contemporaneously over multiple iterations leading to more accurate cameras and improved depiction of 3D movements.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code;
the hardware processor configured to execute the software code to:
receive a plurality of video sequences each generated by a respective one of a plurality of cameras, each of the plurality of video sequences depicting a respective one of a plurality of three-dimensional (3D) movements of a subject from a different perspective;
align a respective direction of a 3D trajectory of the subject in each of the plurality of video sequences;
predict, after aligning, a sequence of poses of the subject based on a plurality of predetermined keypoints of the subject in each video frame of the plurality of video sequences; and
calibrate, based on the plurality of the 3D movements and the sequence of poses, a location of each of the plurality of cameras.

2. The system of claim 1, wherein aligning is performed by solving for an affine transformation that minimizes differences of the 3D trajectory of the subject in each of the plurality of video sequences.

3. The system of claim 1, further comprising a trained machine learning (ML) model, and wherein the sequence of poses is predicted using the trained ML model.

4. The system of claim 1, wherein the subject includes a skeleton, and the plurality of predetermined keypoints of the subject comprise joints of the skeleton.

5. The system of claim 1, wherein at least one of the plurality of predetermined keypoints of the subject comprises a vertex, a boundary point, or a centroid of the subject.

6. The system of claim 1, wherein predicting the sequence of poses of the subject and calibrating the location of each of the plurality of cameras are performed in respective iterative processes occurring contemporaneously.

7. The system of claim 1, wherein the hardware processor is further configured to execute the software code to:
determine, using a plurality of 3D foot positions of the subject in the plurality of video sequences, a position of a ground plane on which the plurality of the 3D movements of the subject occur.

8. The system of claim 1, wherein the location of each of the plurality of cameras is a 3D location.

9. The system of claim 1, wherein each of the plurality of video sequences further depicts a respective one of a plurality of 3D movements of another subject from the different perspective, the hardware processor further configured to execute the software code to:
align a respective direction of a 3D trajectory of the another subject in each of the plurality of video sequences;
predict, after aligning the direction of the 3D trajectory of the another subject, a sequence of poses of the another subject based on a plurality of predetermined keypoints of the another subject in each video frame of the plurality of video sequences; and
wherein calibrating the 3D location of each of the plurality of cameras is further based on the plurality of 3D movements of the another subject and the sequence of poses of the another subject.

10. The system of claim 9, wherein at least one of the plurality of cameras is in motion.

11. A method for use by a system including a hardware processor and a memory storing a software code, the method comprising:
receiving, by the software code executed by the hardware processor, a plurality of video sequences each generated by a respective one of a plurality of cameras, each of the plurality of video sequences depicting a respective one of a plurality of three-dimensional (3D) movements of a subject from a different perspective;
aligning, by the software code executed by the hardware processor, a respective direction of a 3D trajectory of the subject in each of the plurality of video sequences;
predicting, by the software code executed by the hardware processor after aligning, a sequence of poses of the subject based on a plurality of predetermined keypoints of the subject in each video frame of the plurality of video sequences; and
calibrating, by the software code executed by the hardware processor based on the plurality of the 3D movements and the sequence of poses, a location of each of the plurality of cameras.

12. The method of claim 11, wherein aligning is performed by solving for an affine transformation that minimizes differences of the 3D trajectory of the subject in each of the plurality of video sequences.

13. The method of claim 11, wherein the system further comprises a trained machine learning (ML) model, and wherein the sequence of poses is predicted using the trained ML model.

14. The method of claim 11, wherein the subject includes a skeleton, and the plurality of predetermined keypoints of the subject comprise joints of the skeleton.

15. The method of claim 11, wherein at least one of the plurality of predetermined keypoints of the subject comprises a vertex, a boundary point, or a centroid of the subject.

16. The method of claim 11, wherein predicting the sequence of poses of the subject and calibrating the location of each of the plurality of cameras are performed in respective iterative processes occurring contemporaneously.

17. The method of claim 11, further comprising:
determining, by the software code executed by the hardware processor and using a plurality of 3D foot positions of the subject in the plurality of video sequences, a position of a ground plane on which the plurality of the 3D movements of the subject occur.

18. The method of claim 11, wherein the location of each of the plurality of cameras is a 3D location.

19. The method of claim 11, wherein each of the plurality of video sequences further depicts a respective one of a plurality of 3D movements of another subject from the different perspective, the method further comprising:
aligning, by the software code executed by the hardware processor, a respective direction of a 3D trajectory of the another subject in each of the plurality of video sequences;
predicting, by the software code executed by the hardware processor after aligning the direction of the 3D trajectory of the another subject, a sequence of poses of the another subject based on a plurality of predetermined keypoints of the another subject in each video frame of the plurality of video sequences; and
wherein calibrating the 3D location of each of the plurality of cameras is further based on the plurality of 3D movements of the another subject and the sequence of poses of the another subject.

20. The method of claim 19, wherein at least one of the plurality of cameras is in motion.
